(19) United States
(12) Patent Application Publication
(10) Pub. No.: US 2021/0118192 A1
(43) Pub. Date: Apr. 22, 2021

(54) IMAGE DISPLAY SYSTEM

(71) Applicant: Toyota Jidosha Kabushiki Kaisha, Toyota-shi Aichi-ken (JP)

(72) Inventors: Kenji Sato, Toyota-shi (JP); Kei Yamamoto, Toyota-shi (JP); Takashi Nishimoto, Owariasahi-shi (JP)

(21) Appl. No.: 17/070,145

(22) Filed: Oct. 14, 2020

(30) Foreign Application Priority Data
Oct. 16, 2019 (JP) 2019-189666

(51) Int. Cl. G06T 11/00; G09G 3/3208

(52) U.S. Cl. CPC G06T 11/00; G09G 2380/10; G09G 2354/00; G09G 3/3208

(57) ABSTRACT

An image processing system includes a wearable device worn by a passenger of a vehicle, and an on-board system. The wearable device includes an organic EL display for displaying an image within a visual field of the passenger. The on-board system includes an image processor configured to generate an image for altering at least one of an outer appearance, a position, and visibility of a component or the passenger of the vehicle, and cause the display device to display the image. This alters color densities and graphical patterns of a roof ceiling, a left A pillar, a right A pillar, a frame of a left triangle window, a left front door trim panel, a frame of a right triangle window, a right front door trim panel, an instrument panel, a center console, a driver seat, a driver seat floor, a front passenger seat, and a front passenger seat floor.

### CROSS REFERENCE TO RELATED APPLICATION

This application claims priority to Japanese Patent Application No. 2019-189666 filed on Oct. 16, 2019, which is incorporated herein by reference in its entirety including the specification, claims, drawings, and abstract.

### TECHNICAL FIELD

The present disclosure relates to an image display system used by a passenger of a vehicle.

### BACKGROUND

There has been known a technique of displaying images of the outside of a vehicle on a display device installed in a cabin of the vehicle.

JP 2010-58742 A discloses a drive assisting device for a vehicle that captures an image of a region in a blind spot which is hidden from a driver by a view obstructing member, such as a front pillar, and displays the captured image on the view obstructing member.

In addition, a technique for displaying various items of information on a display device worn by a driver or other passengers of a vehicle has been known.

Meanwhile, J P 2004-219664 A describes that information, such as navigation information for navigating to a destination, and facility guidance information, is displayed in connection with roads, buildings, etc. on a display device worn by a driver of a vehicle.

On the other hand, JP 2005-96750 A discloses that information about functions of a vehicle, such as a vehicle speed, an engine speed, and a fuel level, is displayed on a display device worn by a driver of the vehicle.

### SUMMARY

In the techniques described in the above three patent publications JP 2010-58742 A, JP 2004-219664 A, and JP 2005-96750 A, the display devices are merely configured to additionally display information about the outside of a vehicle or information about functions of the vehicle.

It is an object of the present disclosure to display an image, which is generated based on a different concept from a conventional technical concept, on a display device worn by a passenger of a vehicle, to thereby provide the passenger with a novel visual environment.

In an aspect, an image display system according to the present disclosure includes a display device, which is worn by a passenger of a vehicle and is configured to display an image within a visual field of the passenger, and an image processor, which is configured to generate an image for altering at least one of an outer appearance, a position, and visibility of a component, the passenger wearing the display device, or another passenger of the vehicle, and cause the display device to display the generated image.

In an aspect of this disclosure, the image processor is configured to generate an image for altering at least one of a position, an outer appearance, and visibility of the component of the vehicle, and cause the display device to display the generated image.

In an aspect of this disclosure, the component is an interior component installed in a cabin of the vehicle, and the image processor is configured to generate an image for altering the outer appearance of the interior component, the outer appearance being related to at least one of a color, a graphic pattern, and a texture of the interior component, and cause the display device to display the generated image.

In an aspect of this disclosure, the display device is configured to be worn by a driver of the vehicle, the component is an inner mirror or an outer mirror, and the image processor is configured to generate an image for altering a position of the inner mirror or the outer mirror, the image electronically representing the inner mirror or the outer mirror at a position close to a steering wheel, and cause the display device to display the generated image.

In an aspect of this disclosure, the component is at least one of an engine, a wheel, and a suspension which are installed in a region forward of the cabin in the vehicle, and the image processor is configured to generate an image for altering visibility of the component, the image representing the component in a state of being seen through from the cabin, and cause the display device to display the generated image.

In an aspect of this disclosure, the image processor is configured to generate an image for altering an outer appearance of the passenger of the vehicle, and cause the display device to display the generated image.

In an aspect of this disclosure, the display device is configured to be worn by the driver of the vehicle, and the image processor is configured to generate the altering image within a region which is not directly related to operation to drive the vehicle by the driver, and cause the display device to display the generated image.

According to the present disclosure, the image is displayed to make a change to at least one of the outer appearance, the position, and visibility of the component or the passenger, so that an unusual visual environment that is different from reality can be provided to the passenger. For example, when the outer appearance of the interior component is altered, the passenger can enjoy driving in a more refreshing mood than usual. Further, it may be expected, for example, that representation of the wheel or the engine can give the passenger pleasure in driving.

### BRIEF DESCRIPTION OF DRAWINGS

Embodiments of the present disclosure will be described based on the following figures, wherein:

FIG. 1 is a block diagram representing a configuration of an image display system according to an embodiment;

FIG. 2 is an external view of a wearable device worn by a driver;

FIG. 3 shows the driver's visual field in which no image is displayed;

FIG. 4 shows the driver's visual field in which outer appearances of interior components are altered;

FIG. 5 shows the driver's visual field in which mirrors are displayed on positions that are different from positions of actual mirrors;

FIG. 6 shows the driver's visual field in which an engine and other components are visualized in a state of been seen through; and

FIG. 7 shows the driver's visual field in which the pattern of clothing of the driver is altered.

### DESCRIPTION OF EMBODIMENTS

Hereinafter, embodiments will be described with reference to the drawings. In the following description, specific embodiments are explained for better understanding. The embodiments are presented by way of illustration, and the present disclosure may be embodied in other various ways.

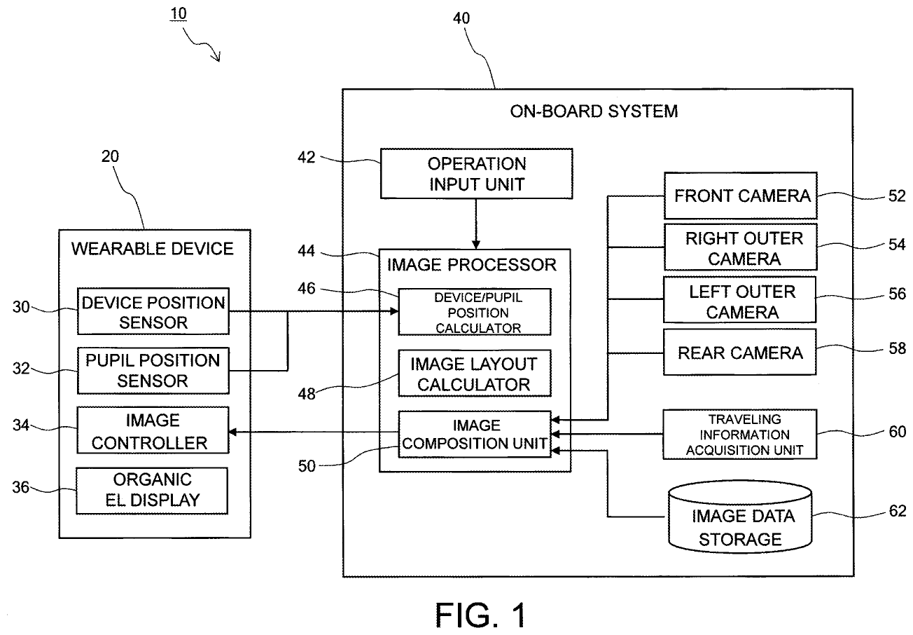

FIG. 1 is a block diagram showing functional configuration of an image display system 10 according to an embodiment. The image display system 10 includes a wearable device 20 and an on-board system 40.

The wearable device 20 is a device which is worn in a manner similar to spectacles or goggles by an occupant, such as a driver, of a vehicle. The wearable device 20 includes a device position sensor 30, a pupil position sensor 32, an image controller 34, and an organic electroluminescence (EL) display 36.

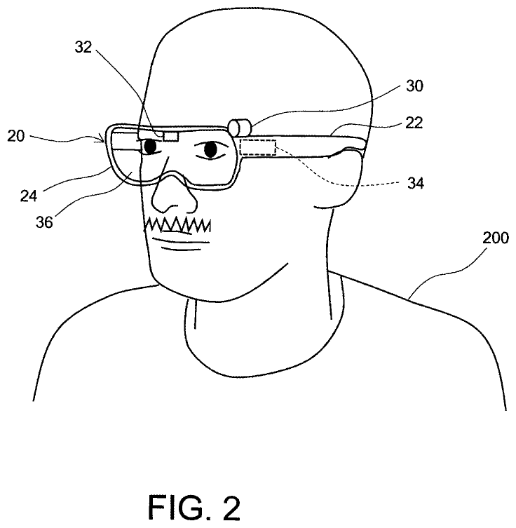

Here, the wearable device 20 is explained in detail with reference to FIG. 2. FIG. 2 shows the wearable device 20 in a state where it is worn by a driver 200. The wearable device 20 is a device formed in the shape of spectacles, and may be referred to as smart glasses in some cases. The wearable device 20 includes temples 22 which are linear frame members designed to be put on ears of a user, and a rim 24 joined to the temples 22, the rim 24 being a frame member designed to surround the eyes of the user and to be put on the nose of the user.

The organic EL display 36 being a display device is arranged within the rim 24. The organic EL display 36, which is positioned so as to cover a region in front of the eyes of the driver 200, has a high degree of transparency (high light transmittance) for allowing the driver 200 to view forward through the organic EL display when no image is displayed thereon. An image may be formed on a part or the whole part of the organic EL display 36 under the control of the image controller 34.

The device position sensor 30 is disposed in the vicinity of a coupling area between the rim 24 and the temple 22 close to the left eye of the driver 200. The device position sensor 30 is configured to detect a position of the wearable device 20 within the vehicle.

The device position sensor 30 can be implemented, for example, by means of a camera for capturing an image of a forward area. Specifically, a position and a tilt of the camera can be found by comparing an image captured by the camera with data of an interior layout of the vehicle. Therefore, the camera fixedly mounted on the rim 24 can be used for detecting the position and tilt of the wearable device 20.

The pupil position sensor 32 is disposed on an upper portion of the rim 24 around the center thereof. The pupil position sensor 32 is configured to detect positions of pupils in the right and left eyes of the driver 200 relative to the rim 24. The pupil position sensor 32 may be implemented by means of a camera or the like as in the case of the device position sensor 30.

The temple 22 internally incorporates the image controller 34. The image controller 34 is configured to display an image on the organic EL display 36 based on data received from the on-board system 40. The wearable device 20 can provide the passenger with a visual environment that is different from an ordinary environment through image representation performed by the image controller 34 and the organic EL display 36.

Returning to FIG. 1, the on-board system 40 is explained below. The on-board system 40 is a system mounted on the vehicle. The on-board system 40 includes an operation input unit 42, an image processor 44, a front camera 52, a right outer camera 54, a left outer camera 56, a rear camera 58, a traveling information acquisition unit 60, and an image data storage 62.

The operation input unit 42 is provided for allowing the driver 200 to operate the image display system 10. The driver 200 can instruct whether or not an image is displayed on the wearable device 20, and if displayed, which image is displayed thereon, using the operation input unit 42. Examples for displaying the image will be described further below.

The operation input unit 42 may be composed of buttons which are displayed on a touch panel of an instrument panel. Alternatively, the operation input unit 42 may be composed of mechanical buttons disposed on the instrument panel. Still alternatively, the operation input unit 42 may be provided to the wearable device 20.

The image processor 44 is a device for generating the image to be displayed on the wearable device 20. The image processor 44 may be implemented by controlling computer hardware, which is equipped with a memory, a processor, and other units, using an operating system (OS) or software, such as an application program.

The image processor 44 includes a device/pupil position calculator 46, an image layout calculator 48, and an image composition unit 50. The device/pupil position calculator 46 calculates a relative position of the wearable device 20 within the vehicle and a relative position of the pupils of the driver 200 based on inputs from the device position sensor 30 and the pupil position sensor 32 (such as, for example, inputs of images captured by the camera as described above).

For image representation instructed from the operation input unit 42, the image layout calculator 48 performs calculation to find which image is displayed at which position; that is, calculation to determine a layout of images to be composed. To determine the layout, the image layout calculator 48 uses previously stored relative positions of components of the vehicle, and also uses the relative positions of the wearable device 20 and of the pupils that are calculated in the device/pupil position calculator 46. Using the relative positions, the image layout calculator 48 is able to calculate a position through which a line connecting the pupils of the driver 200 and a particular component of the vehicle passes the organic EL display 36. Then, the image layout calculator 48 calculates a position on the organic EL display 36 where a particular image is displayed, for causing the particular image to be superimposed on the particular component of the vehicle in sight of the driver 200.

The image composition unit 50 performs processing to compose images and other information stored in the image data storage 62, based on the layout calculated in the image layout calculator 48. As the images to be composed, data stored in the image data storage 62 is used as needed. The resulting composite image is transmitted to the image controller 34 and displayed on the organic EL display 36. Transmission of the composite image may be performed through wired communication or wireless communication. When wireless communication is employed, short range wireless communication, such as, for example, Bluetooth (registered trademark) communication, Wi-Fi (registered trademark) communication, and infrared communication, may be utilized.

The front camera 52 is a camera for capturing an image of an area to the front of the vehicle. The right outer camera 54 is a camera for capturing an image of an area to the rear on the right side, and is disposed on the right side of the vehicle. The left outer camera 56 is a camera for capturing an image of an area to the rear on the left side, and is disposed on the left side of the vehicle. The images captured by the right outer camera 54 and the left outer camera 56 are used as images of electronic outer mirrors which can function as substitutes for an optical right outer mirror and an optical left outer mirror. The rear camera 58 is a camera for capturing an image to the rear, and is disposed at the widthwise center of the vehicle. The image captured by the rear camera 58 is used as an image of an electronic inner mirror which can function as a substitute for an optical inner mirror (also referred to as a compartment mirror).

The traveling information acquisition unit 60 acquires information about traveling motion of the vehicle, such as a speed, a steering angle, and a lateral inclination of the vehicle.

When the vehicle is an engine vehicle, the traveling information acquisition unit 60 additionally acquires engine RPM, state of a transmission, and the like. On the other hand, when the vehicle is an electric vehicle, the traveling information acquisition unit 60 additionally acquires RPM of a drive motor and the like. The above-described information can be acquired from, for example, an Electronic Control Unit (ECU) which controls traveling motion of the vehicle. The acquired traveling information is used for operation to display images of the engine, the drive motor, the suspension, wheels, and other components.

The image data storage 62 is a device which is implemented by means of a semiconductor memory, for example, and is controlled by the image processor 44. The image data storage 62 stores images to be displayed on the wearable device 20. Data of the images stored in the image data storage 62 includes images and data indicative of outer appearances of vehicle components. Specifically, the data may include data indicative of outer appearances of interior components, such as a door trim panel, a seat, and a roof ceiling, data indicative of components which are related to traveling motion, such as the engine, a cylinder and a piston in the engine, the drive motor, the suspension, the wheels, and a brake, and data indicative of mirror components, such as the electronic outer mirror, and the electronic inner mirror. Further, the image data storage 62 stores images and data indicative of the outer appearance of a passenger of the vehicle. Specifically, the images and data indicative of the passenger may include images and data for altering a color, a graphic pattern, and/or a texture of the skin or clothing of the passenger, and images and data for altering an appearance of the head of the passenger.

The on-board system 40 performs real time processing. Specifically, the on-board system 40 acquires detection data from the device position sensor 30 and the pupil position sensor 32 in the wearable device 20 at extremely short time intervals. The device/pupil position calculator 46 swiftly calculates, based on the acquired detection data, the position of the wearable device 20 and the position of the pupils. Then, the image layout calculator 48 calculates the layout of images instructed from the operation input unit 42. The image composition unit 50 combines the images received from the image data storage 62 based on the calculated layout to generate a composite image, and transmits the composite image to the wearable device 20.

In the wearable device 20, the received composite image is processed in the image controller 34, and displayed on the organic EL display 36. All processes to achieve image representation are performed at high speed to enable rapid following of the driver 200, such as, for example, processing to follow the driver 200 when they shake their head. Therefore, the driver 200 who wears the wearable device 20 can feel as if a vehicle cabin is actually present, the vehicle cabin being viewed through the wearable device 20 displaying the composite image that is different from reality.

It should be noted that the wearable device 20 has been described with reference to the example wearable device including the image controller 34 and the organic EL display 36, but the wearable device 20 may be implemented based on another principle. For example, the wearable device 20 may be embodied in a form incorporating a projector which projects an image onto the retina of the eye. Meanwhile, the wearable device 20 may be of a type which does not involve visible rays of light, and displays images captured by a camera.

In addition, the system configuration illustrated in FIG. 1 is merely an example, and may be modified, for example, in such a manner that all of the components of the on-board system 40 are installed in the wearable device 20.

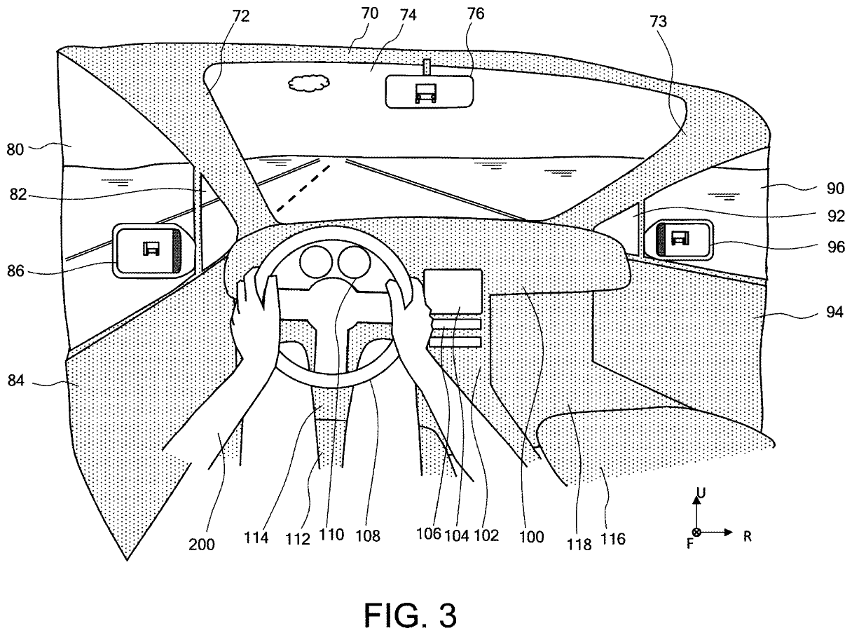

Next, examples of image representation performed by the wearable device 20 will be explained with reference to FIGS. 3 to 7. FIGS. 3 to 7 are schematic diagrams showing the visual field of the driver 200 wearing the wearable device 20. In the diagrams, an F axis of the illustrated coordinate system represents a vehicle front direction, a U axis represents an upward direction, and an R axis represents a right hand direction of the passenger in the vehicle. The driver 200 is seated on a driver seat disposed on the left side of the vehicle.

FIG. 3 shows the view of the driver 200 in a state where the wearable device 20 is not used. In this state, the view of the driver 200 is identical to that seen with the naked eyes of the driver 200.

The view includes, in its upper part, a roof 70, and includes a left A pillar 72 (which is also referred to as a left front pillar) and a right A pillar 73 on the left and right sides of the roof 70. In the view, a front wind shield 74 (also referred to as a front glass) is shown in a region surrounded by the roof 70, the left A pillar 72, and the right A pillar 73. The view further includes a road extending forward on a plain that is seen through the front wind shield 74. The view also includes, at a position close to a top part of the front wind shield 74, an inner mirror 76 attached to the roof 70, and the inner mirror 76 reflects a vehicle traveling behind.

The view includes, on the left side of the driver 200, a left front side wind shield 80 (which may be referred to as a left front side glass), and a left triangle window 82 located forward of the left front side wind shield 80. A left front door trim panel 84 disposed on the inside of a left front door is shown below the left front side window shield 80. Further, a left outer mirror 86 is shown within the left front side wind shield 80, and reflects a part of a side surface of the driver 200's own vehicle in addition to another vehicle traveling behind the driver 200's own vehicle.

The view further includes, on the right side of the driver 200, a right front side wind shield 90, and a right triangle window 92 located forward of the right front side wind shield 90. A right front door trim panel 94 disposed on the inside of a right front door is shown below the right front side window shield 90. Further, a right outer mirror 96 is shown within the right front side wind shield 90, and reflects a part of a side surface of the driver 200's own vehicle in addition to the other vehicle traveling behind.

In the view, an instrument panel 100 is located below the front wind shield 74. A center console 102 is joined to a lower central part of the instrument panel 100. A touch panel 104 and operation buttons 106 are disposed on the instrument panel 100 and the center console 102. The operation input unit 42 of the wearable device 20 worn by the driver 200 is arranged, for example, on the touch panel 104 or the buttons 106.

A steering wheel 108 is disposed forward of the driver 200 and rearward of the instrument panel 100. Both hands of the driver 200 are holding the steering wheel 108. Further, meters 110, such as a speed meter, arranged on the instrument panel 100 are shown inside the steering wheel 108. The view further includes, below the steering wheel 108, a driver seat 112 on which the driver 200 is seated, and a driver seat floor 114 forward of the driver seat 112. On the right side of the center console 102, a front passenger seat 116 and a front passenger seat floor 118 located forward of the front passenger seat 116 are shown.

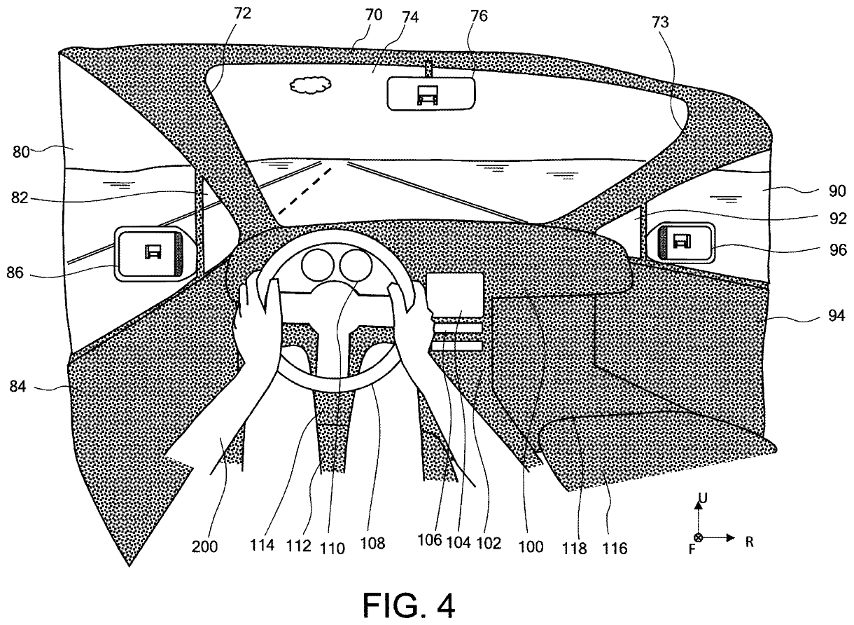

FIG. 4 shows the view field of the driver 200 in a state where outer appearances of the interior components which are not directly related to operation to drive the vehicle are altered in accordance with an instruction input from the operation input unit 42 by the driver 200. Specifically, in an example illustrated in FIG. 4, color densities and graphic patterns of the roof 70, the left A pillar 72, the right A pillar 73, a frame of the left triangle window 82, the left front door trim panel 84, a frame of the right triangle window 92, the right front door trim panel 94, the instrument panel 100, the center console 102, the driver seat 112, the driver seat floor 114, the front passenger seat 116, and the front passenger seat floor 118 are altered. These components are interior components which are disposed within the cabin of the vehicle, and have a characteristic feature of increasing an aesthetic design quality, but are not directly related to the operation to drive the vehicle. The interior components which are not directly related to the operation to drive the vehicle may also include a seat belt, a rear seat, a rear seat floor, a rear door trim panel, a B pillar, a C pillar, and a panel member located rearward of a rear passenger seat, which are not illustrated in FIG. 4.

The wearable device 20 can alter at least one of the color, the graphic pattern, and the texture of the interior components using the images and data stored in the image data storage 62. Here, the texture denotes a feature about a material, including, for example, a metallic feature, a wooden feature, a leather-like feature, and a cushiony feature.

Alteration of the outer appearances of the interior components can lead to a change in the impression of the cabin, which can, in turn, change a mood or feeling of the driver 200. Accordingly, the driver 200 who is in their vehicle, can change the outer appearances of the interior components every day, for example, to feel as if they were driving a vehicle different from their own vehicle and thus enjoy driving.

In the example illustrated in FIG. 4, the outer appearances of the interior components are all altered so as to have the same color, the same pattern, and the same texture. Alternatively, for example, the outer appearances of the components may be altered differently on a component-by-component basis, or only some of the components may have their outer appearances altered while maintaining the other components unaltered.

The outer appearances of the interior components which are not directly related to the operation to drive the vehicle may be altered in a situation where the vehicle is moving. However, in consideration of a possibility that concentration of the driver 200 will be lost due to the alteration of the outer appearances, altering operation may be enabled only when the vehicle is stopped. Specifically, in the traveling vehicle, the altering operation may be enabled when the vehicle is temporarily stopped due to a red light or the like, or enabled only in a state where the vehicle is not ready to move (such as, for example, a state where a shift lever is in a parking position, or a state where the parking brake is set).

In the example illustrated in FIG. 4, the outer appearances of the front wind shield 74, the left front side wind shield 80, the left triangle window 82, the right front side wind shield 90, and the right triangle window 92 are not altered. The above-noted shields and windows may be considered as the interior components which are disposed within the cabin, and have the feature of increasing the aesthetic quality. However, while driving, the driver 200 always observes traffic situations outside the vehicle through the front wind shield 74, the left front side wind shield 80, the left triangle window 82, the right front side wind shield 90, and the left front side wind shield 80, the left triangle window 82, the right front side wind shield 90, and/or the right triangle window 92, to drive the vehicle. Therefore, the shields and the windows are necessary for the driver 200 to view the outside of the vehicle during driving, and are thus considered as the interior components which are directly related to the operation to drive the vehicle. For this reason, the outer appearances of the shields and the windows are not modified in the example illustrated in FIG. 4.

Further, in the example illustrated in FIG. 4, outer appearances of the touch panel 104, the operation buttons 106, the steering wheel 108, and the meters 110 are not altered. Those components are the interior components directly related to the operation to drive the vehicle. Therefore, the outer appearances of the components are not altered in light of avoiding deterioration in viewability by the driver 200, or avoiding a possibility that the driver 200 will be confused by the alterations. However, the above components may be altered when the alteration has only a slight influence on the operation to drive the vehicle. For example, the steering wheel 108 is operated while being touched by the driver 200, and it may be considered that the alteration to an outer appearance of the steering wheel 108 has a small influence on the operation to drive the vehicle. Therefore, a setting to enable the alteration of the outer appearance of the steering wheel 108 may be employed.

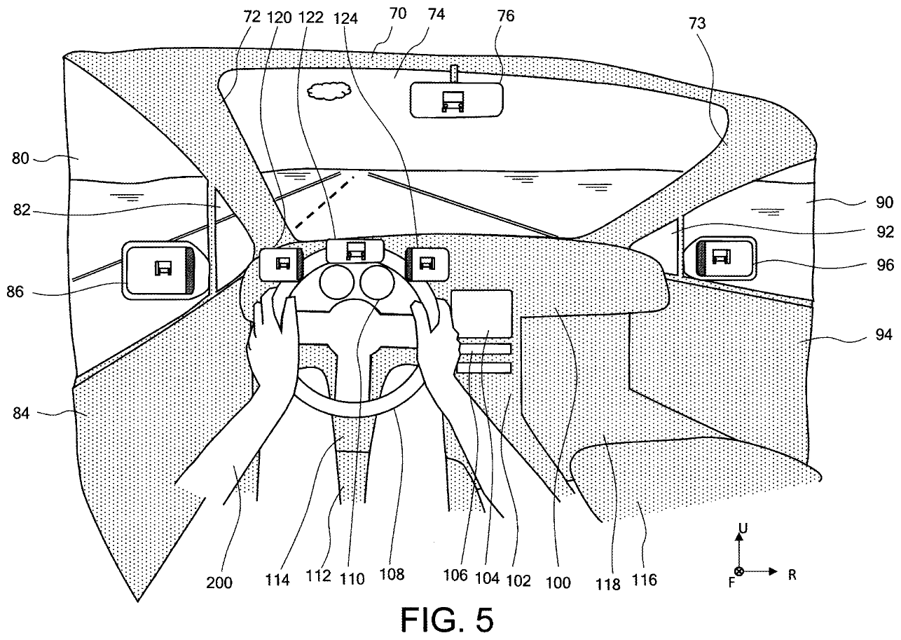

FIG. 5 shows the view field of the driver 200 in a state where electronic mirrors are displayed in accordance with an instruction input from the operation input unit 42 by the driver 200. In an example illustrated in FIG. 5, an electronic left outer mirror 120, an electronic inner mirror 122, and an electronic right outer mirror 124 are displayed in that order from the left in an area close to the top portion of the steering wheel 108.

The electronic left outer mirror 120 is an electronic mirror for displaying an image captured from an area to the rear on the left side of the vehicle by the left outer camera 56. The electronic left outer mirror 120 displays a portion of the side surface of the driver 200's own vehicle and the other vehicle traveling behind, as in the case of the left outer mirror 86 being the optical mirror.

The electronic inner mirror 122 is an electronic mirror for displaying an image captured from an area to the rear of the vehicle by the rear camera 58. The electronic inner mirror 122 displays the other vehicle traveling behind, as in the case of the inner mirror 76. The electronic right outer mirror 124 is an electronic mirror for displaying an image captured from an area to the rear on the right side of the vehicle by the right outer camera 54. The electronic right outer mirror 124 displays a portion of the side surface of the driver 200's own vehicle and the other vehicle traveling behind, as in the case of the right outer mirror 96.

The electronic left outer mirror 120, the electronic inner mirror 122, and the electronic right outer mirror 124 are displayed in the area close to the top portion of the steering wheel 108 on a driver 200 side of the steering wheel 108. Because the driver 200 rarely touches the top portion of the steering wheel 108, the presence of a partially hidden area in the top portion of the steering wheel 108 constitutes almost no hindrance to the operation to drive the vehicle. On the other hand, the electronic left outer mirror 120, the electronic inner mirror 122, and the electronic right outer mirror 124 displayed on the top portion of the steering wheel 108 allow the driver 200 to check the area to the rear of the vehicle without substantially shifting their line of sight from the front view. Further, the electronic left outer mirror 120, the electronic inner mirror 122, and the electronic right outer mirror 124, which are displayed below the lower end of the front wind shield 74, constitute no hindrance to a forward view field of the driver 200. Still further, the electronic left outer mirror 120, the electronic inner mirror 122, and the electronic right outer mirror 124 are disposed at positions which do not overlap the meters 110, and thus constitute no hindrance to reading the meters 110.

In the example illustrated in FIG. 5, the left outer mirror 86, the inner mirror 76, and the right outer mirror 96 are also present, as in the case of the example illustrated in FIG. 3. The left outer mirror 86, the inner mirror 76, and the right outer mirror 96 are physically installed optical mirrors, and remain existing even though the operation to display the electronic mirrors is input through the operation input unit 42. For this reason, even when representations of the electronic left outer mirror 120, the electronic inner mirror 122, and the electronic right outer mirror 124 are lost due to a failure of the wearable device 20, there is no hinderance in driving. The driver 200 can view the left outer mirror 86, the inner mirror 76, and the right outer mirror 96 to keep driving.

Meanwhile, while the electronic left outer mirror 120, the electronic inner mirror 122, and the electronic right outer mirror 124 are displayed, images captured from areas hidden behind the left outer mirror 86, the inner mirror 76, and the right outer mirror 96 may be displayed on the mirrors 86, 76, and 96. This can enhance viewability by the driver 200 to observe the outside of the vehicle.

It should be noted that the example illustrated in FIG. 5 may be applied to a vehicle in which physical display devices are installed in place of the left outer mirror 86, the inner mirror 76, and the right outer mirror 96, and are configured to function as mirrors, rather than incorporating the physical mirrors 86, 76, and 96.

In the example illustrated in FIG. 5, the left outer mirror 86, the inner mirror 76, and the right outer mirror 96 which are originally installed in the vehicle are displayed as images (i.e. as the electronic left outer mirror 120, the electronic inner mirror 122, and the electronic right outer mirror 124) at different positions in different sizes changed from the original mirrors 86, 76, and 96. When a component mounted on the vehicle is displayed at a different position by means of the wearable device 20 as described above, it becomes possible to enhance operability of the vehicle. Further, an effect of improving safety can be expected from the enhanced operability of the vehicle.

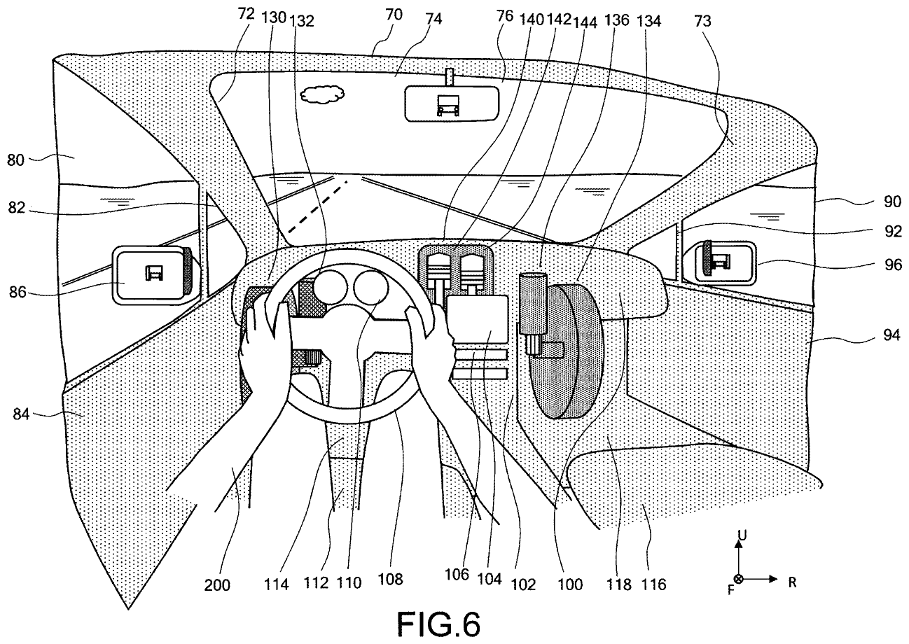

FIG. 6 shows the visual field in which components, which are installed in a vehicle front region and are thus invisible to the driver 200, are visualized as if the components were seen through obstacles in the cabin in accordance with an instruction input from the operation input unit 42 by the driver 200. That is, in an example illustrated in FIG. 6, visibility of the components in the vehicle is altered. As used herein, visibility is an index or a scale representing whether or not it is viewable by a driver, how clearly it is viewed, or to what extent it is viewed.

In the example illustrated in FIG. 6, a left front wheel 130, a left front suspension 132, a right front wheel 134, a right front suspension 136, and the engine 140, which are all visually unobservable in normal situations, are visualized in a state where they are seen through obstacles in the cabin. Representations of those components are created so as to reflect traveling information acquired by the traveling information acquisition unit 60.

The left front wheel 130 and the left front suspension 132 are represented at positions behind the steering wheel 108 on the left side thereof. The positions are defined to approximately correspond to actual positions of the left front wheel 130 and the left front suspension 132 which would be seen through over the instrument panel 100, a dash panel located forward of the instrument panel 100, and other components if the instrument panel 100, the dash panel, and the other components were transparent. The left front wheel 130 and the left front suspension 132 are represented so as to hide (or translucently cover) a portion of the instrument panel 100 that is not directly related to the operation to drive the vehicle. On the other hand, the left front wheel 130 and the left front suspension 132 are represented in such a manner that the driver 200 is able to see the meters 110, the steering wheel 108, and the driver 200 themselves as usual without being hidden by the left front wheel 130 and the left front suspension 132. Such a manner of representation is determined in consideration of minimizing influence on the operation to drive the vehicle.

Similarly, the right front wheel 134, the right front suspension 136, and the engine 140 are represented in a state where the driver 200 see the right front wheel 134, the right front suspension 136, and the engine 140 through the instrument panel 100 and other components. For the engine 140, however, its representation is created so as to be hidden behind the touch panel 104, the steering wheel 108, and the hands of the driver 200, rather than being seen through the touch panel 104, the steering wheel 108, and the hands of the driver 200, which is intended to minimize influence on the operation to drive the vehicle.

The rotational speed of the left front wheel 130 and the right front wheel 134 changes as a travel speed of the vehicle changes. In this regard, the driver 200 is able to intuitively feel the speed of the vehicle when the left front wheel 130 and the right front wheel 134 are represented. Further, angles of the left front wheel 130 and the right front wheel 134 are changed in response to steering of the steering wheel 108. Therefore, representations of the left front wheel 130 and the right front wheel 134 can provide the driver 200 with an intuitive feeling of turning at a curve.

Representations of the left front wheel 130 and the right front wheel 134 can be created based on images of actual wheels that are captured, for example, in an automotive factory. Alternatively, virtual reality images, for example, which are generated from 3D data of the wheels, may be used. In the displayed wheels, the rotational speed of the wheels may not exactly match that of the actual wheels as long as the rotational speed of the displayed wheels changes with the speed of the vehicle.

The left front suspension 132 and the right front suspension 136 are components which function to mitigate an impact force in a vertical direction of the vehicle, for improving cushioning characteristics of the vehicle. The left front suspension 132 and the right front suspension 136 undergo extension and contraction following bumps and dips of a lumpy road surface, and undergo extension and contraction following changes in load during travel through a curve or during a braking operation. Therefore, when the left front suspension 132 and the right front suspension 136 are displayed, the driver 200 becomes able to intuitively feel the behavior of the vehicle in the vertical direction.

Representations of the left front suspension 132 and the right front suspension 136 can be created based on images of actual suspensions that are captured, for example, in the automotive factory. Alternatively, virtual reality images, for example, which are generated from 3D data of the suspensions, may be used. In the displayed suspensions, a degree of extension and contraction may not exactly match that of the actual suspensions as long as the displayed suspensions are extended and contracted based on actual extension and contraction.

The engine 140 is equipped with cylinders 142 and 144 in which pistons are reciprocated. The engine rpm is determined by the number of reciprocations of the pistons. Therefore, when motion of the pistons is displayed, the driver 200 can intuitively feel the behavior of the engine.

It is almost impossible to capture images of inner areas of the cylinders 142 and 144. Therefore, virtual reality images created from 3D data of the cylinders 142 and 144 and the pistons are displayed. In the displayed images, the number of times of piston's reciprocation may not exactly match that of the actual pistons as long as it changes in accordance with the actual number of reciprocations.

When the left front wheel 130, the left front suspension 132, the right front wheel 134, the right front suspension 136, and the engine 140 are displayed as described above, the driver 200 can intuitively feel the behavior of the traveling vehicle. Accordingly, the driver 200 can drive the vehicle while intuitively feeling of the behavior of the vehicle. Further, it can be expected that such representations have an effect of raising the driver 200′ awareness of safe driving.

In addition to the components illustrated in FIG. 6, or in place of the components illustrated in FIG. 6, other components, such as a brake, a drive motor, a head lamp for illuminating forward, a turning indicator lamp, and rear wheels, may be visualized as described above.

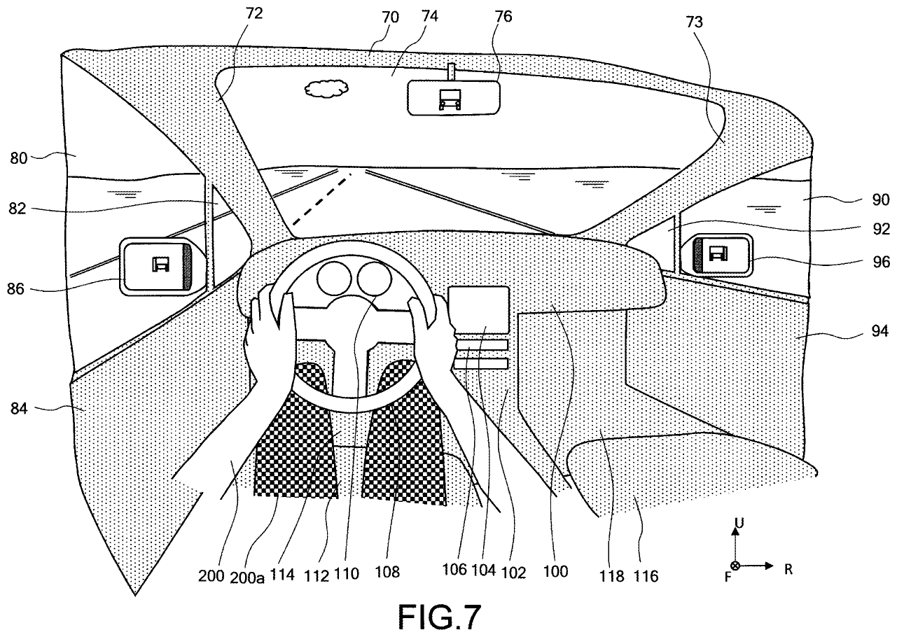

FIG. 7 shows the visual field in a state where a pattern of clothing of the driver 200 is altered in accordance with an instruction input from the operation input unit 42 by the driver 200. Specifically, in an example illustrated in FIG. 7, the outer appearance of trousers 200a of the driver 200 is changed from plain cloth to checkered cloth. The trousers 200a are displayed while being partially hidden by the steering wheel 108 and the hands and arms of the driver 200 as in the case of the example illustrated in FIG. 3, without changing a location of the trousers 200a. This allows the driver 200 to feel as if they had changed the trousers 200a.

Similarly, the color, the graphic pattern, and the texture of clothing of the driver 200 or another passenger of the vehicle may be altered, and even the shape of clothing may be changed (for example, from short trousers to long trousers, or from a T shirt to a dress shirt). Images of clothes to be changed are previously stored in the image data storage 62, so that clothing can be changed.

Information about the position, the outline, and other features of the driver 200 or the other passenger can be acquired by comparing information of the inside of the vehicle cabin including the passenger, such as the driver 200 or the other passenger, with information of the inside of the vehicle cabin including no passenger. Specifically, the information about the position, the outline, and the other features of the passenger can be acquired by subtracting data captured by a camera incorporated into the wearable device 20 and data of the inside of the vehicle cabin including no passenger. In addition, distinguishing clothes of the passenger from the skin of the passenger, and distinguishing faces of passengers, can be achieved, for example, using a learning algorithm for pattern recognition.

In the example illustrated in FIG. 7, the outer appearance of the hands and arms of the driver 200 is not altered. However, the color of the skin of the driver 200 may be altered. The color of the skin may be selected in a realistic way to change a condition as to whether or not the skin is tanned, for example, or may be changed, in an unrealistic way, to green or pink, for example. A graphic pattern may be displayed on the skin, or a property of the skin may be changed to a metallic property, for example.

In addition, the face or the entire head of the driver 200 or the other passenger may be changed. Such a change may include, for example, a form of changing a fellow passenger to a well-known figure, a cartoon character, or the like.

When the clothing, the skin, the head, and other features of the driver 200 or the other passenger are changed to have unusual appearances that are different from real features as described above, the driver 200 can enjoy driving in a more refreshing mood.

In the above description, the examples for displaying the images on the wearable device 20 worn by the driver 200 have been explained. Similarly, the wearable device 20 may be worn by a passenger other than the driver 200, and various images may be displayed on the wearable device 20 of the other passenger. Display settings for the wearable device 20 of the passenger other than the driver 200 may be identical to those of the driver 200 (for example, the outer appearances of the interior components are altered in the same manner for the driver 200 and the other passenger), or may differ between the driver 200 and the other passenger. For the passenger other than the driver 200, the display setting may be determined without considering operability to drive the vehicle. Therefore, it is possible to display an image which reduces visibility of the front wind shield 74. Further, when the driver 200 does not need to substantially operate the vehicle in a case where the vehicle has an automatic driving mode, the operability to drive the vehicle may not necessarily be considered in displaying an image on the wearable device 20 of the driver 200.

In an embodiment of this disclosure, it is possible to generate an image for altering at least one of the outer appearance, the position, and visibility of a component or a passenger (who may be the driver or the fellow passenger) of the vehicle, and cause the display device to display the generated image. In generalization, an image for altering at least one of an outer appearance, a position, visibility of an object (which may be the component or the passenger of the vehicle) existing in a cabin of a vehicle may be generated and the display device may be operated to display the generated image. In another embodiment, an image for altering at least one of the outer appearance, the position, and visibility of a component installed outside the cabin may be generated, and the display device may be operated to display the generated image.

1. An image display system, comprising:
a display device that is worn by a passenger of a vehicle, and is configured to display an image within a visual field of the passenger;
an image processor that is configured to generate an image for altering at least one of an outer appearance, a position, and visibility of a component of the vehicle or the passenger, and cause the display device to display the generated image.

2. The image display system according to claim 1, wherein
the image processor is configured to generate an image for altering at least one of the position, the outer appearance, and visibility of the component of the vehicle, and cause the display device to display the generated image.

3. The image display system according to claim 2, wherein:
the component is an interior component installed in a cabin of the vehicle; and
the image processor is configured to generate an image for altering at least one of a color, a graphic pattern, and a texture of the interior component, and cause the display device to display the generated image.

4. The image display system according to claim 2, wherein:
the display device is configured to be worn by a driver of the vehicle;
the component is an inner mirror or an outer mirror; and
the image processor is configured to;
generate an image for altering a position of the inner mirror or the outer mirror, the image electronically representing the inner mirror or the outer mirror at a position close to a steering wheel, and
cause the display device to display the generated image.

5. The image display system according to claim 2, wherein:
the component is at least one of an engine, a wheel, and a suspension which are installed in a region forward of a cabin of the vehicle; and
the image processor is configured to;
generate an image for altering visibility of the component, the image representing the component in a state of being seen from inside the cabin through other intervening components, and
cause the display device to display the generated image.

6. The image display system according to claim 1, wherein:
the image processor is configured to generate an image for altering an outer appearance of the passenger of the vehicle, and cause the display device to display the generated image.

7. The image display system according to claim 1, wherein:
the display device is configured to be worn by a driver of the vehicle; and
the image processor is configured to generate the altering image within a region which is not directly related to operation to drive the vehicle by the driver, and cause the display device to display the generated image.
